(19) United States
(12) Patent Application Publication
(10) Pub. No.: US 2010/0079527 A1
(43) Pub. Date: Apr. 1, 2010

(54) IMAGE RECORDING APPARATUS AND IMAGE RECORDING METHOD

(76) Inventor: Kazuo SANADA, Kanagawa-ken (JP)

Correspondence Address: BIRCH STEWART KOLASCH & BIRCH, PO BOX 747, FALLS CHURCH, VA, 22040-0747, US

(21) Appl. No.: 12/569,808

(22) Filed: Sep. 29, 2009

(30) Foreign Application Priority Data
Sep. 30, 2008 (JP) 2008-253429

(51) Int. Cl. B41J 29/38

(52) U.S. Cl. 347/14

(57) ABSTRACT

The image recording apparatus includes: a recording head which has at least one row of recording elements arranged at a prescribed arrangement interval in a sub-scanning direction, the recording head having overlap sections at both end portions of the recording head, an arrangement density of the recording elements as expressed as a number of the recording elements per unit length gradually becoming smaller towards an end of the recording head in each of the overlap sections; a scanning device which moves the recording head in a main scanning direction with respect to a recording medium; a conveyance device which conveys the recording head and the recording medium relatively to each other in the sub-scanning direction; and a conveyance control device which controls the conveyance device, wherein where s is a number of multiple passes which is a number of recording actions on a same main scanning line, D is a maximum value of the arrangement density of the recording elements, and k is a ratio of a recording density in the sub-scanning direction with respect to the maximum value D of the arrangement density of the recording elements, the conveyance control device controls the conveyance device so as to move at least one of the head and the recording medium in such a manner that the overlap sections of the recording head are mutually complemented by means of s×k movements in the sub-scanning direction, and a remainder that is obtained by multiplying a total amount of movement to each of the s×k movements in the sub-scanning direction by the maximum value D of the arrangement density of the recording elements and multiplying a resulting product by the recording density ratio k, and then dividing a resulting product by the recording density ratio k, becomes a combination of values from 0 to k−1 that are equal in number to the number of multiple passes s.

### BACKGROUND OF THE INVENTION

1. Field of the Invention

The present invention relates to an image recording apparatus and an image recording method, and more particularly to serial scanning image recording technology which carries out a desired image recording on a recording medium by scanning the recording medium with a recording head in a main scanning direction while intermittently conveying the recording medium in a sub-scanning direction.

2. Description of the Related Art

An inkjet recording apparatus is suitable for use as a general output apparatus for images and texts, and the like. In image recording using an inkjet recording apparatus, ink is ejected from a plurality of nozzles provided in an inkjet recording head in accordance with image data, thereby forming a desired image on a recording medium.

An inkjet recording apparatus employs a composition using a serial scanning method which records an image on a recording medium by alternately repeating image recording in the main scanning direction and intermittent conveyance of the recording medium in the sub-scanning direction. Image recording based on the serial scanning method employs technology for suppressing the occurrence of periodic density non-uniformities caused by variations in nozzle ejection characteristics (the ink ejection direction) by using technology such as an “interlacing” which carries out recording adjacent rasters (dot columns arranged in the main scanning direction) by different nozzles and a “multi-scan (singling)” which carries out image recording by a plurality of main scanning operations in respect of a region where image recording is possible in one main scanning operation.

Japanese Patent Application Publication No. 05-057965 discloses technology for preventing banding or non-uniformities in joint sections in the sub-scanning direction, in an inkjet recording apparatus based on the serial scanning method, by providing overlap regions corresponding to the joint sections in the sub-scanning direction, and combining a gradual decrease and a gradual increase in the recorded dot density so as to prevent a sudden discontinuity of the recorded image in the overlap regions.

Japanese Patent Application Publication No. 09-011509 discloses a color printer including a print head having N nozzles arranged in the sub-scanning direction at the nozzle pitch of k times the dot pitch of the printed image in the sub-scanning direction, wherein the respective nozzles are driven at intermittent timings during main scanning of the print head, dots are formed at intervals of s times the dot pitch, and the feed amount L in the sub-scanning direction which is performed after the main scanning is set to be L=N/(s×D×k), where D is the number of the nozzles per unit length in the sub-scanning direction, thereby achieving improvement in printing quality and improvement in throughput.

Japanese Patent Application Publication No. 2006-027131 discloses an inkjet recording apparatus which prevents banding (conspicuous stripe-shaped deterioration of image quality in the main scanning direction), by carrying out recording by setting for each main scanning operation a conveyance amount and number of nozzles used which are different to those set for the previous main scanning operation.

However, if it sought to improve the quality of the recorded image by using these technologies simultaneously, there are problems as follows.

In the image recording method described in Japanese Patent Application Publication No. 05-057965, since there are nozzles that are not used when recording an overlap region, then there are restrictions on the feed amount in the sub-scanning direction. In other words, in order to complement the nozzles that are not used in an overlap region in multi-pass recording, each time a stipulated number of sub-scanning conveyance actions is performed, it is necessary to set the total of the stipulated number of sub-scanning conveyance actions to “number of nozzles”/“dot density outside joint sections”.

On the other hand, the image recording methods described in Japanese Patent Application Publication Nos. 09-011509 and 2006-27131 are premised on using for image recording nozzles determined on the basis of the parameters s and k, the dot pitch and the sub-scanning direction feed amount L, and therefore it is difficult to combine these with the image recording method described in Japanese Patent Application Publication No. 05-057965 in respect of image recording in joint sections in the sub-scanning direction.

### SUMMARY OF THE INVENTION

The present invention has been contrived in view of these circumstances, an object thereof being to provide an image recording apparatus and an image recording method which achieve desirable image recording by preventing density non-uniformities in joint sections in a sub-scanning direction, as well as preventing stripe-shaped non-uniformities in a main scanning direction.

In order to attain the aforementioned object, the present invention is directed to an image recording apparatus, comprising: a recording head which has at least one row of recording elements arranged at a prescribed arrangement interval in a sub-scanning direction, the recording head having overlap sections at both end portions of the recording head, an arrangement density of the recording elements as expressed as a number of the recording elements per unit length gradually becoming smaller towards an end of the recording head in each of the overlap sections; a scanning device which moves the recording head in a main scanning direction with respect to a recording medium; a conveyance device which conveys the recording head and the recording medium relatively to each other in the sub-scanning direction; and a conveyance control device which controls the conveyance device, wherein where s is a number of multiple passes which is a number of recording actions on a same main scanning line, D is a maximum value of the arrangement density of the recording elements, and k is a ratio of a recording density in the sub-scanning direction with respect to the maximum value D of the arrangement density of the recording elements, the conveyance control device controls the conveyance device so as to move at least one of the head and the recording medium in such a manner that the overlap sections of the recording head are mutually complemented by means of s×k movements in the sub-scanning direction, and a remainder that is obtained by multiplying a total amount of movement to each of the s×k movements in the sub-scanning direction by the maximum value D of the arrangement density of the recording elements and multiplying a resulting product by the recording density ratio k, and then dividing a resulting product by the recording density ratio k, becomes a combination of values from 0 to k−1 that are equal in number to the number of multiple passes s.

According to the present invention, in image recording based on a multi-pass method using a serial scanning type of recording head which has overlap sections in which the arrangement density of the recording elements gradually becomes smaller, since the relative movement of the recording head and the recording medium is controlled in such a manner that the respective overlap sections are mutually complemented by s×k movements in the sub-scanning direction, which is the product of the number of multiple passes s and the maximum value D of the recording element density, and furthermore since the relative movement of the recording head and the recording medium is controlled in such a manner that the remainder obtained by multiplying the total amount of movement to each of the s×k movements in the sub-scanning direction by the recording element density D, multiplying by the recording density ratio k, and dividing by the recording density ratio k, is a combination of values from 0 to k−1 which are equal in number to the number of multiple passes s, then in image recording which combines a multi-pass method and an interlace method, density non-uniformities in the joint portions in the sub-scanning direction are avoided, in addition to which stripe-shaped non-uniformities due to fluctuation in the intrinsic characteristics of the recording elements are also avoided.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus according to an embodiment of the present invention;

FIG. 2 is a general schematic drawing showing the composition of the periphery of the print unit of the inkjet recording apparatus shown in FIG. 1;

FIG. 3 is a cross-sectional diagram showing the structure of the head shown in FIG. 2;

FIG. 4 is a cross-sectional diagram of a further mode of the head shown in FIG. 2;

FIG. 5 is a plan diagram showing an example of the arrangement of nozzles in the head shown in FIG. 2;

FIG. 6 is a principal block diagram showing the system configuration of the inkjet recording apparatus shown in FIG. 1;

FIG. 7 is a schematic drawing showing an image recording method according to an embodiment of the present invention;

FIG. 8 is a diagram showing an example of a dot arrangement recorded by the image recording method according to the embodiment of the present invention;

FIG. 9 is a diagram showing an example of recording in an end portion of the recording paper in the image recording method according to the embodiment of the present invention;

FIG. 10 is a diagram showing an example of dots recorded in the image recording method according to the embodiment of the present invention;

FIG. 11 is a general schematic drawing of an inkjet recording apparatus according to an application embodiment of the present invention;

FIG. 12 is a diagram illustrating a matrix configuration;

FIG. 13 is a diagram showing head modules of a full line type of head;

FIG. 14 is a diagram showing head modules which are different to the head modules shown in FIG. 13;

FIG. 15 is a diagram showing a nozzle arrangement in the end portion of the head module;

FIG. 16 is a diagram illustrating an image recording method in the related art;

FIG. 17 is a diagram showing the beneficial effects of the image recording method according to the embodiment of the present invention; and

FIG. 18 is a table which compares the image recording method according to the embodiment of the present invention and the image recording method in the related art.

### DETAILED DESCRIPTION OF THE PREFERRED EMBODIMENTS

### General Configuration of Inkjet Recording Apparatus

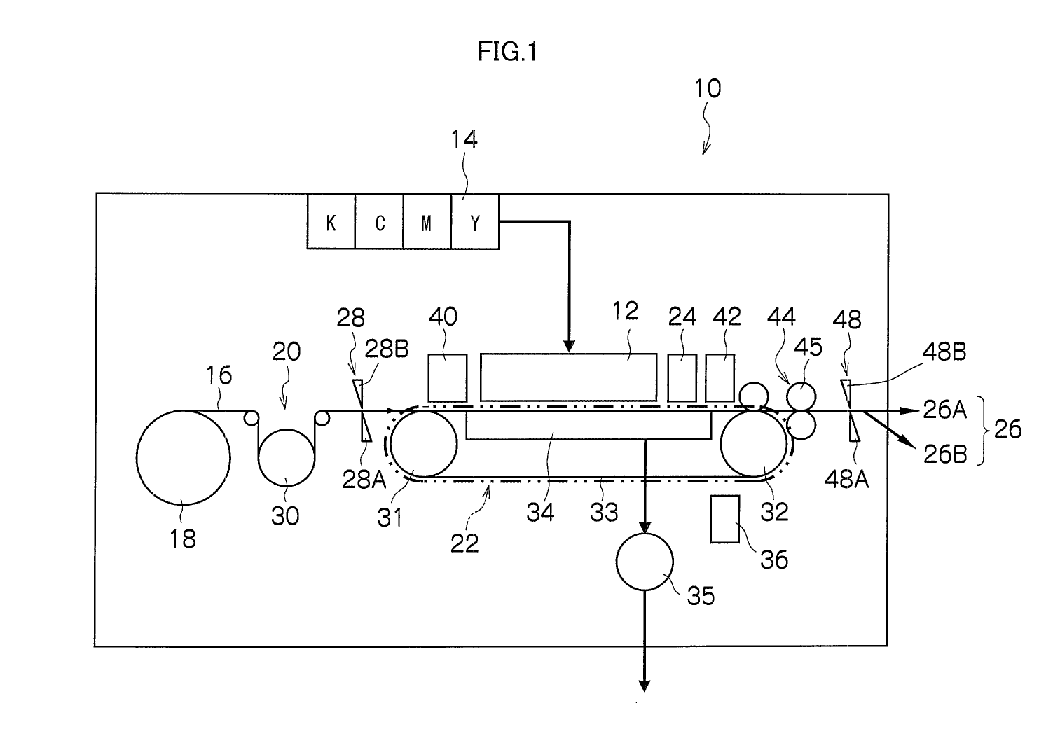

FIG. 1 is a schematic diagram showing a general configuration of an inkjet recording apparatus 10 according to an embodiment of the present invention.

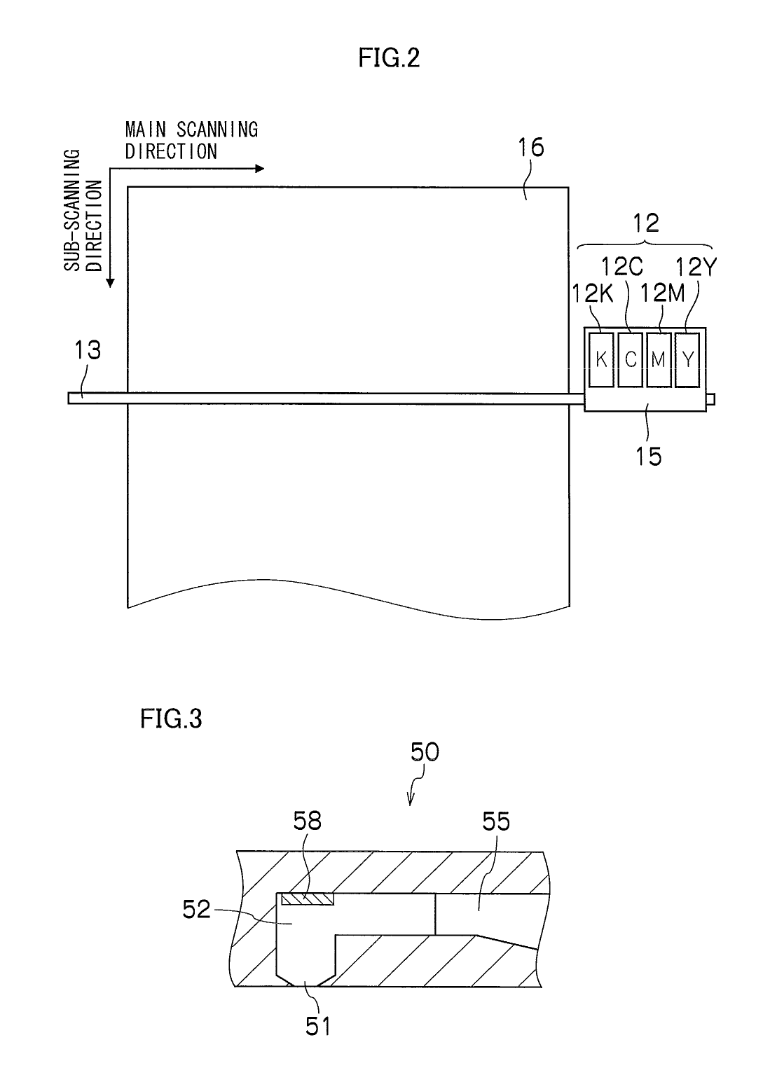

As shown in FIG. 1, the inkjet recording apparatus 10 includes: a print unit 12 having a plurality of inkjet heads 12K, 12C, 12M, and 12Y (not shown in FIG. 1, but shown in FIG. 2) provided for ink colors of black (K), cyan (C), magenta (M), and yellow (Y), respectively; an ink storing and loading unit 14 for storing inks of K, C, M and Y to be supplied to the inkjet heads; a paper supply unit 18 for supplying recording paper 16; a decurling unit 20 removing curl in the recording paper 16; a suction belt conveyance unit 22 disposed facing the nozzle face (ink-droplet ejection face) of the print unit 12, for conveying the recording paper 16 while keeping the recording paper 16 flat; a print determination unit 24 for reading the printed result produced by the print unit 12; and a paper output unit 26 for outputting image-printed recording paper (printed matter) to the exterior.

In FIG. 1, a magazine for rolled paper (continuous paper) is shown as an example of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of the configuration in which roll paper is used, a cutter 28 is provided as shown in FIG. 1, and the continuous paper is cut into a desired size by the cutter 28. The cutter 28 has a stationary blade 28A, whose length is not less than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut papers are used, the cutter 28 is not required.

In the case of a composition where recording papers of a plurality of types can be used, desirably, an information recording body, such as a bar code or a wireless tag, which records information about the paper type is attached to the magazine, and the type of paper used is identified automatically by reading in the information on this information recording body by means of a prescribed reading apparatus, the ejection of ink being controlled so as to achieve suitable ink ejection in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite to the curl direction in the magazine. In this, the heating temperature is preferably controlled in such a manner that the medium has a curl in which the surface on which the print is to be made is slightly rounded in the outward direction.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the print unit 12 forms a flat plane.

The belt 33 has a width that is greater than the width of the recording paper 16, and a plurality of suction apertures (not shown) are formed on the belt surface. A suction chamber 34 is disposed in a position facing the nozzle surface of the print unit 12 on the interior side of the belt 33, which is set around the rollers 31 and 32, as shown in FIG. 1. The suction chamber 34 provides suction with a fan 35 to generate a negative pressure, and the recording paper 16 on the belt 33 is held by suction.

The belt 33 is driven in the clockwise direction in FIG. 1 by the motive force of a motor (not shown) being transmitted to at least one of the rollers 31 and 32, which the belt 33 is set around, and the recording paper 16 held on the belt 33 is conveyed in the paper conveyance direction (sub-scanning direction; direction to the right in FIG. 1).

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, examples thereof include a configuration in which the belt 33 is nipped with cleaning rollers such as a brush roller and a water absorbent roller, an air blow configuration in which clean air is blown onto the belt 33, or a combination of these. In the case of the configuration in which the belt 33 is nipped with the cleaning rollers, it is preferable to make the line velocity of the cleaning rollers different than that of the belt 33 to improve the cleaning effect.

The inkjet recording apparatus 10 can have a roller nip conveyance mechanism, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the print unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

The ink storing and loading unit 14 has tanks (main tanks) which store inks of colors corresponding to the respective heads of the print unit 12. Moreover, the ink storing and loading unit 14 also has a notifying device (display device, alarm generating device, or the like) for generating a notification if the remaining amount of ink has become low, as well as having a mechanism for preventing incorrect loading of ink of the wrong color.

The print determination unit 24 has an image sensor (line sensor or the like) for capturing an image of the ink-droplet deposition result of the print unit 12, and functions as a device to check for ejection defects such as clogs of the nozzles or the variation in the droplet ejection speed (ejection characteristics) of the nozzles based on the ink-droplet deposition images read by the image sensor.

The print determination unit 24 of the present embodiment is configured with a line sensor having rows of photoelectric transducing elements with a width that is greater than the image recording width of the recording paper 16. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 determines the ejection from the respective heads by reading in a test pattern which has been printed by the heads of the respective colors, The ejection determination includes the presence of ejection, measurement of the dot size, and measurement of the dot landing position.

A heating fan 40 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B. Although not shown, the paper output unit 26A for the target prints is provided with a sorter for collecting prints according to print orders.

Although a configuration with four standard colors, K, M, C and Y, is described in the present embodiment, the combinations of the ink colors and the number of colors are not limited to these, and light and/or dark inks can be added as required. For example, it is possible to adopt a composition which additionally comprises heads for ejecting light inks, such as light cyan, light magenta, and the like.

FIG. 2 is a general schematic drawing showing the composition of the periphery of the print unit 12 in the inkjet recording apparatus 10. The inkjet recording apparatus 10 has a carriage 15, which is able to move reciprocally in the breadthways direction of the recording paper 16 (main scanning direction) while being guided on a guide rail 13. The inkjet heads 12K, 12C, 12M and 12Y corresponding respectively to the inks of the colors black (K), cyan (C), magenta (M) and yellow (Y) are mounted on the carriage 15.

The inkjet recording apparatus 10 described in the present embodiment employs a serial scanning method in which image recording is performed in the main scanning direction by ejecting ink droplets of corresponding colored inks respectively from the nozzles of the heads 12K, 12C, 12M and 12Y while scanning the recording medium by moving the carriage 15 on which the heads 12K, 12C, 12M and 12Y are mounted in the main scanning direction, conveying the recording paper 16 by a prescribed amount in the sub-scanning direction after performing one image recording action in the main scanning direction, and then performing a subsequent image recording action in the main scanning direction, these operations being repeated so as to recording a desired image on the recording paper 16.

### Structure of Head

Next, the structure of the heads 12K, 12C, 12M and 12Y will be described. The heads 12K, 12C, 12M and 12Y of the respective ink colors have the same structure, and a reference numeral 50 is hereinafter designated to any of the heads.

FIG. 3 is a cross-sectional diagram showing the three-dimensional structure of a head 50. As shown in FIG. 3, each head 50 includes a plurality of nozzles 51 which eject ink, pressure chambers (liquid chambers) 52 provided so as to correspond respectively to each of the plurality of nozzles 51, and a common flow channel 55 connected to the respective pressure chambers 52 which distributes and supplies ink to the respective pressure chambers 52. Furthermore, a heater 58 is provided as a heating element inside each pressure chamber 52, and an ink droplet is ejected from the nozzle 51 by utilizing the heat energy generated by the heater 58.

Instead of a thermal method which employs the heat energy of the heater 58 as shown in FIG. 3, it is also possible to employ a piezo jet method which applies mechanical energy due to the deformation of a piezoelectric element to the ink inside the pressure chamber 52.

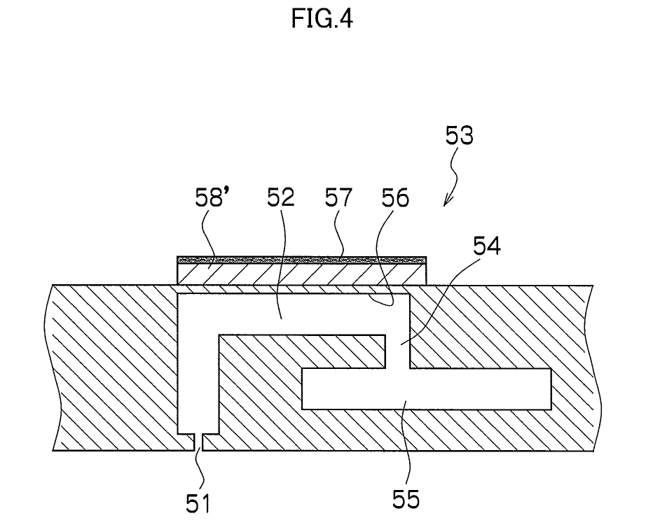

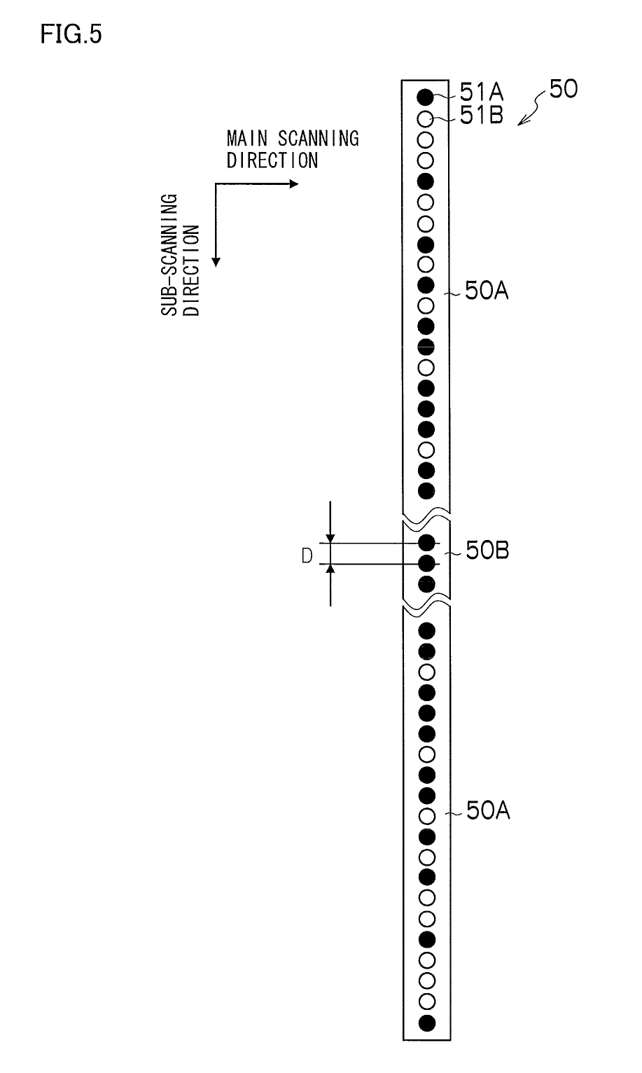

FIG. 4 is a cross-sectional diagram of a head 50 which employs a piezo jet method. In FIG. 4, parts which are the same as or similar to FIG. 3 are denoted with the same reference numerals and further explanation thereof is omitted here.

As shown in FIG. 4, the head 50 includes a plurality of ink chamber units 53. Each of the ink chamber units 53 has a nozzle 51 which is an ink droplet ejection hole, a pressure chamber 52 corresponding to the nozzle 51, and the like. Each pressure chamber 52 provided corresponding to the nozzle 51 has a substantially square planar shape (not illustrated), and the nozzle 51 and a supply port 54 are arranged in opposing corners on a diagonal of this planar shape. The pressure chambers 52 are connected to a common channel 55 through the supply ports 54. The common channel 55 is connected to an ink supplying tank (not shown), which is a base tank that supplies ink, and the ink supplied from the ink supplying tank is delivered through the common flow channel 55 to the pressure chambers 52.

A piezoelectric element 58′ provided with an individual electrode 57 is bonded to a diaphragm 56 which forms the upper face of the pressure chamber 52 and also serves as a common electrode, and the piezoelectric element 58′ is deformed when a drive signal is supplied to the individual electrode 57, thereby causing ink to be ejected from the nozzle 51. When ink is ejected, new ink is supplied to the pressure chamber 52 from the common flow passage 55, via the supply port 54.

Each head 50 is also integrated with a respective sub tank, and ink stored in the sub tank is supplied progressively in accordance with consumption of ink by the head, during a recording operation. Furthermore, if the remaining amount of ink inside the sub tank reaches a prescribed amount or lower as the recording operation progresses, then the carriage 15 is moved to a prescribed standby position as shown in FIG. 2 (maintenance position). In the standby position, ink is supplied to the sub tank from the main tank and when the sub tank has become filled with ink, the recording operation is restarted. The main tank is equivalent to the ink storing and loading unit 14 shown in FIG. 1. Furthermore, it is also possible to employ a cartridge system in which a replaceable ink cartridge can be mounted on the carriage 15 and the ink cartridge is replaced as and when the ink inside the cartridge has run out.

### Description of Nozzle Arrangement

Next, the arrangement of nozzles in the head 50 employed in the present embodiment will be described. FIG. 5 is an approximate plan diagram showing the nozzle arrangement in the head 50.

The head 50 shown in FIG. 5 has a structure in which a plurality of nozzles 51 are aligned in a single row in the sub-scanning direction. An overlap section 50A provided in each end portion of the head 50 has a structure whereby the density of the nozzles 51 gradually decreases toward the end of the head. The overlap sections 50A at both end portions of the head 50 have the same nozzle arrangement.

Each of solid circles denoted with reference numeral 51A in FIG. 5 represents a nozzle provided with an opening, and each of outlined circles denoted with reference numeral 51B represents a nozzle omitted part where no opening is provided. On the other hand, in the regions other than the overlap sections 50A, such as the central portion 50B of the head 50, the nozzles 51 are arranged equidistantly at an arrangement density D (dpi).

Although the details are described hereinafter, in image recording using the head 50 shown in FIG. 5, the recording density in the sub-scanning direction is k times the nozzle density D (where k is an integer greater than 1), and taking the nozzle density D to be 600 (dpi), the recording density in the sub-scanning direction when k=2 is 1200 (dpi). Furthermore, a multi-pass method which records by means of s main scanning actions (where is an integer greater than 1) in respect of the same main scanning line is employed, and recording of the nozzle omitted parts 51B in the overlap sections 50A is complemented by other recording actions in the main scanning direction.

It is possible that the nozzle omitted parts 51B shown in FIG. 5 are nozzles which have openings but are not used in recording.

### Description of Control System

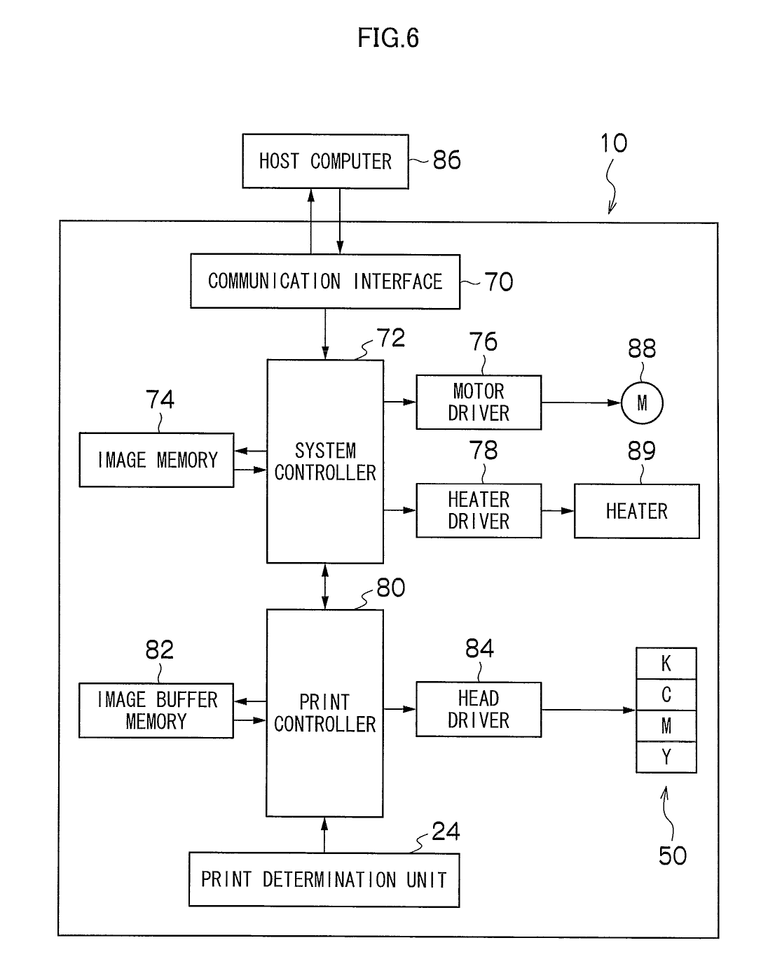

FIG. 6 is a principal block diagram showing the system configuration of the inkjet recording apparatus 10. The inkjet recording apparatus 10 includes a communication interface 70, a system controller 72, an image memory 74, a motor driver 76, a heater driver 78, a print controller 80, an image buffer memory 82, a head driver 84, and the like.

The communication interface 70 is an interface unit for receiving image data sent from a host computer 86. A serial interface or a parallel interface may be used as the communication interface 70. A buffer memory (not shown) may be mounted in this portion in order to increase the communication speed.

The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is a control unit which controls the respective sections, such as the communications interface 70, the image memory 74, the motor driver 76, the heater driver 78, and the like. The system controller 72 is made up of a central processing unit (CPU) and peripheral circuits thereof, and as well as controlling communications with the host computer 86 and controlling reading from and writing to the image memory 74, and the like, it generates control signals for controlling the motors 88 and heaters 89 in the conveyance system.

The motor driver (drive circuit) 76 drives the motor 88 in accordance with commands from the system controller 72.

The heater driver 78 drives the heater 89 of the post-drying unit 42 or other units in accordance with commands from the system controller 72.

The print controller 80 has a signal processing function for performing various tasks, compensations, and other types of processing for generating print control signals from the image data stored in the image memory 74 in accordance with commands from the system controller 72 so as to supply the generated print control signal (dot data) to the head driver 84. Prescribed signal processing is carried out in the print controller 80, and the ejection amount and the ejection timing of the ink droplets from the respective print heads 50 are controlled via the head driver 84, on the basis of the print data. By this means, prescribed dot size and dot positions can be achieved.

The print controller 80 is provided with the image buffer memory 82; and image data, parameters, and other data are temporarily stored in the image buffer memory 82 when image data is processed in the print controller 80. The aspect shown in FIG. 6 is one in which the image buffer memory 82 accompanies the print controller 80; however, the image memory 74 may also serve as the image buffer memory 82. Also possible is an aspect in which the print controller 80 and the system controller 72 are integrated to form a single processor.

The head driver 84 generates drive signals for driving the heaters 58 (or piezoelectric elements 58′) of the recording heads 50 of the respective colors, on the basis of dot data supplied from the print controller 80, as well as supplying the generated drive signals to the heaters 58 (or piezoelectric elements 58′). A feedback control system for maintaining constant drive conditions in the head 50 may be included in the head driver 84.

The print determination unit 24 reads in a test pattern recorded by the head 50 and performs prescribed signal processing, and the like, to determine the ink ejection status of the head 50 (presence or absence of ejection, dot size, dot position, and the like). The determination results are sent to the print controller 80. According to requirements, the print controller 80 makes various corrections with respect to the head 50 on the basis of information obtained through the print determination unit 24.

### Description of Image Recording Method

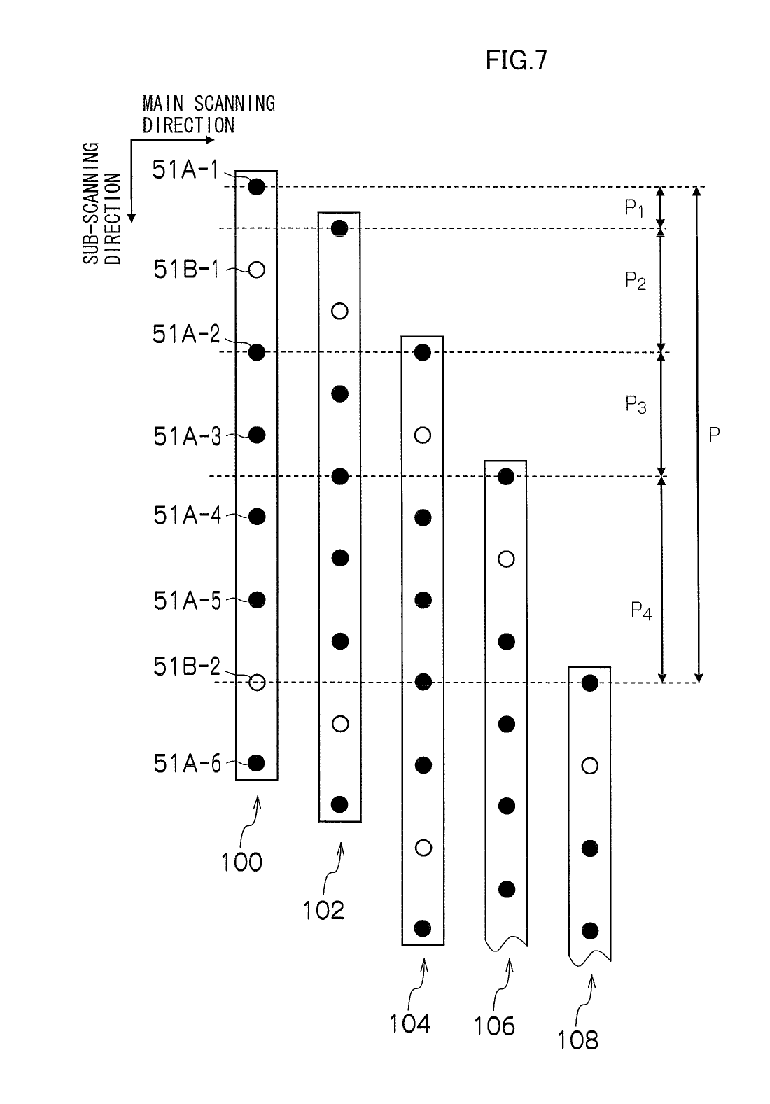

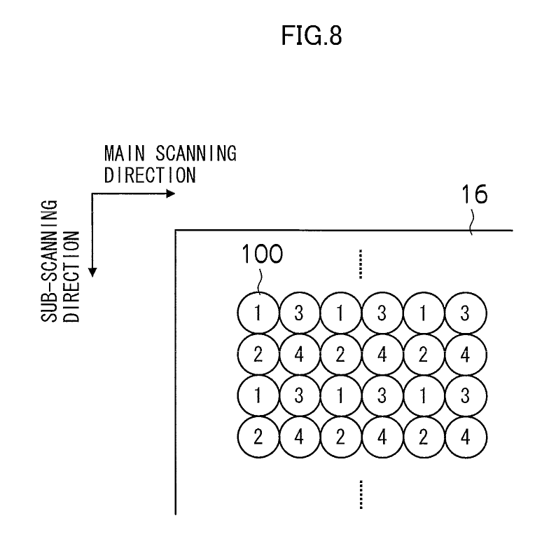

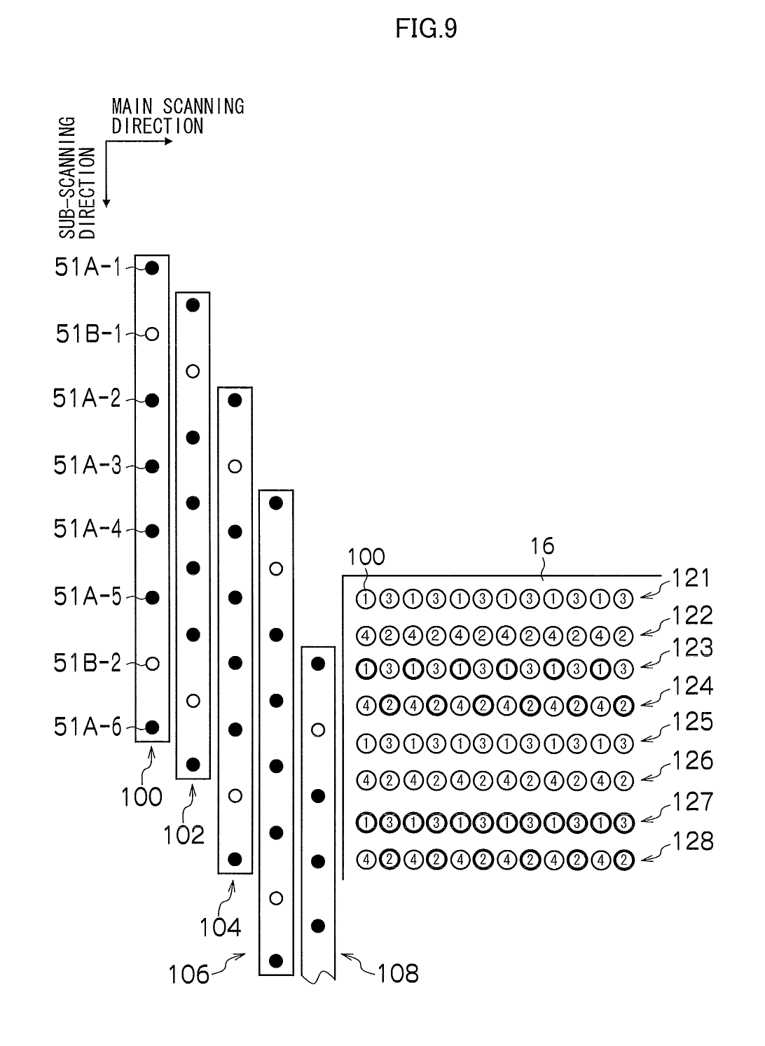

Next, the image recording method used in the inkjet recording apparatus 10 will be described. FIG. 7 is a diagram showing the feed amounts in the sub-scanning direction in the image recording method described in the present embodiment, and FIG. 8 is a diagram representing the dot arrangement recorded by the image recording method. FIG. 9 is a diagram describing an example of image recording in the leading edge portion of the recording paper 16.

In the image recording method described in the present embodiment, a multi-pass method and an interlace method are used in combination, and taking the total number of nozzles to be n, and taking the nozzle density in the portion excluding the overlap sections 50A (see FIG. 5) to be D (dpi), the overlap sections 50A have mutually complementary nozzle arrangements, and recording is carried out at a nozzle density D without producing gaps by conveying the head 50 and the recording paper 16 relatively through the movement amount P=n/D in the sub-scanning direction.

In this case, taking the number of multi-passes (the number of overwrites on the same main scanning line) to be s (where s is an integer greater than 1), taking the ratio of the recording density in the sub-scanning direction with respect to the nozzle density D in the sub-scanning direction (the recording density ratio=recording density/nozzle density D) to be k, and taking the amount of movement P in the sub-scanning direction in one sub-scanning sequence to be the sum of the s×k movements, then the relationship between the number of nozzles n and the amount of movement P in the sub-scanning direction in one sequence (=P₁+P₂+ . . . +P_{s×k}) is expressed by the following formula (1):

n=(P₁+P₂+ . . . +P_{s×k})×D (1)

In other words, the head 50 and the recording paper 16 are conveyed relatively through P (=n/D) as the sum total of the s×k movements in the sub-scanning direction, by the recording in one sub-scanning sequence. As a result of this, the head 50 (or the recording paper 16) is relatively moved to the position where the overlap section 50A (see FIG. 5) is complemented. The amounts of movement in the sub-scanning direction are repeats of one sequence constituted of P₁, P₂, . . . , P_{s×k}.

The amounts of movement in the sub-scanning direction in one sub-scanning sequence, P₁, P₂, . . . , P_{s×k}, are selected in advance in such a manner that the remainder of dividing (P₁×D×k) by k, the remainder of dividing ((P₁+P₂)×D×k) by k, . . . , and the remainder of dividing ((P₁+P₂+ . . . +P_{s×k})×D×k) by k are established by the s combinations from 0 to k−1.

In other words, the position in the sub-scanning direction where recording is carried out in the main scanning direction (the main scanning recording position) includes positions which coincide with the nozzle position in the sub-scanning direction (nozzle position) and positions between mutually adjacent nozzle positions, and there are k−1 main scanning recording positions between the nozzle positions. When the total amount of movement until each main scanning recording position is multiplied by (D×k) and then divided by k, if the remainder of the resulting value is 0, then this means that the position is a nozzle position, and if the remainder is 1 to k−1, then this means that the position is one between nozzle positions.

Next, a concrete example of the above-described amounts of movement in the sub-scanning direction, P₁, P₂, . . . , P_{s×k}, will be described. In the following example, it is supposed that s=2, k=2 and n=6.

FIG. 7 is a schematic drawing describing the amounts of movement in the sub-scanning direction, P₁, P₂, . . . , P_{s×k}, in the above-described conditions. The head 50 shown in FIG. 7 has six nozzles 51A-1 to 51A-6, a nozzle omitted part 51B-1 in an end portion, and another nozzle omitted part 51B-2 in the other end portion. In FIG. 7, for the sake of convenience, it is supposed that the head 50 is moved in the sub-scanning direction (the downward direction in FIG. 7), and the head 50 at its respective halt positions (indicated by reference numerals 100 to 108) is depicted as staggered in the lateral direction in FIG. 7.

In the example shown in FIG. 7, it is supposed that the nozzle 51A-1 is moved to the position of the nozzle omitted part 51B-2 by passing through four movements in the sub-scanning direction, and the four amounts of movement in the sub-scanning direction are P₁=0.5/D, P₂=1.5/D, P₃=1.5/D, P₄=2.5/D. In other words, the feed amount P in the sub-scanning direction in one sequence is P=P₁+P₂+P₃+P₄=6/D.

When a first recording action in the main scanning direction has been performed at the position denoted with reference numeral 100 (a reference position in the sub-scanning direction, nozzle position), then the head 50 and the recording paper (not shown in FIG. 7) are moved relatively through the movement amount P₁ in the sub-scanning direction, and a second recording action in the main scanning direction is carried out at the position denoted with reference numeral 102. This position is a position between the nozzle positions (intermediate position).

After the second recording action in the main scanning direction, the head 50 and the recording paper are conveyed relatively through P₂ in the sub-scanning direction, and a third recording action in the main scanning direction is carried out at the position denoted with reference numeral 104. This position is a nozzle position.

After the third recording action in the main scanning direction, the head 50 and the recording paper are conveyed relatively through P₃ in the sub-scanning direction, and a fourth recording action in the main scanning direction is carried out at the position denoted with reference numeral 106. This position is a nozzle position. Thereupon, the head 50 and the recording paper are conveyed relatively through P₄ in the sub-scanning direction.

In this way, by performing four movements of the movement amounts P₁ to P₄ in the sub-scanning direction, the nozzle 51-1 is moved to a position for complementing the nozzle omitted part 51B-2. The movement in the sub-scanning direction until this point is taken as one sequence, and this sequence is carried out repeatedly. In other words, in the movement in the sub-scanning direction in one sequence, the main scanning recording position when s=2 and k=2 will be s×k (=4), and a nozzle position and an intermediate position are repeatedly alternately, every s (=2) times.

FIG. 8 is a diagram showing the dot arrangement recorded onto the recording paper 16 by means of the recording method described above. In FIG. 8, the numerals 1 to 4 indicated inside the dots 100 represent that the dots are respectively formed by the above-described first to fourth recording actions in the main scanning direction.

As shown in FIG. 8, a dot row in which the dots recorded by a first recording action in the main scanning direction and the dots recorded by a third recording action in the main scanning direction are arranged alternately, and a dot row in which the dots recorded by a second recording action in the main scanning direction and the dots recorded by a fourth recording action in the main scanning direction are arranged alternately, are configured alternately in the sub-scanning direction.

Here, the remainders of the following formulas (2) to (5) are determined specifically as indicated below:

(P₁×D×k)/k (2)

{(P₁+P₂)×D×k}/k (3)

{(P₁+P₂+P₃)×D×k}/k (4)

{(P₁+P₂+P₃+P₄)×D×k}/k (5)

The remainder of the formula (2) is 1 (intermediate position), the remainder of the formula (3) is 0 (nozzle position), the remainder of the formula (4) is 1 (intermediate position), and the remainder of the formula (5) is 0. In other words, the respective movement positions 102 to 108 in the sub-scanning direction are a combination of s (=2) positions having values of 0 and k−1 (=1) for the remainder obtained by multiplying the nozzle density D by the total amount of movement from the reference position 100 to that movement position, multiplying the resulting product by a coefficient k and then dividing the resulting product by k. In this way, the s×k movements P₁ to P_{s×k} in the sub-scanning direction are selected.

In the leading edge portion or the trailing edge portion of the recording paper 16, recording is carried out by using a portion of the nozzles 51A-1 to 51A-6. FIG. 9 is an explanatory diagram which explains an example of recording at the leading edge portion of the recording paper 16.

In FIG. 9, in recording in the main scanning direction at the position denoted with reference numeral 100, the nozzle 51A-5 and the nozzle 51A-6 are used, and the first dot row 121 and the fifth dot row 125 are recorded. In recording in the main scanning direction at the position denoted with reference numeral 102, the nozzle 51A-5 and the nozzle 51A-6 are used, and the second dot row 122 and the sixth dot row 126 are recorded.

In the recording in the main scanning direction at the position denoted with reference numeral 104, the nozzles 51A-3, 51A-4, 51A-5 and 51A-6 are used, and the first dot row 121, the third dot row 123, the fifth dot row 125 and the ninth dot row (not illustrated) are recorded. Since the seventh dot row 127 corresponds to the nozzle omitted part 51B-2, then it is not recorded.

In the recording in the main scanning direction at the position denoted with reference numeral 106, the nozzles 51A-2 to 51A-6 are used, and the second dot row 122, the fourth dot row 124, the sixth dot row 126, the eighth dot row 128 and the twelfth dot row (not illustrated) are recorded. Since the tenth dot row (not illustrated) corresponds to the nozzle omitted part 51B-2, then it is not recorded.

Next, the missing portion of the third dot row 123, and the seventh dot row 127 are recorded, by recording in the main scanning direction at the position denoted with reference numeral 108. The dots recorded in this case are depicted by thick lines. In the next recording in the main scanning direction (the position of the head 50 is not depicted), the dots of the missing portion of the fourth dot row 124 and the missing portion of the eighth dot row 128 are recorded, and in the next recording in the main scanning direction, the dots of the missing portion of the seventh dot row 127 are recorded.

In this way, by selectively using the nozzles 51A-1 to 51A-6 to record the leading edge portion (and trailing edge portion) of the recording paper 16, it is possible to record dots without any omissions.

In respect of the recording density ratio k, if k=3, then there will be two positions between the nozzle positions, and if k=4, then there will be three positions between the nozzle positions. Furthermore, in respect of the number of multi-scans s, if s=3, then there will respectively be three nozzle positions and three positions between the nozzle positions in one sequence of movements in the sub-scanning direction, and if k=4, then there will respectively be four nozzle positions and four positions between the nozzle positions in one sequence of movements in the sub-scanning direction.

Next, the hypothetical case of an actual head composition where n=1024 and D=600 (dpi) will be described. The recording density in the sub-scanning direction is D×k (=600×2)=1200 dpi, one main scanning line is scanned s (=2) times each, the paper is conveyed relatively through P (=n/D=1024/600 dpi) by s×k (=4) movements in the sub-scanning direction, and the joint (complement) in respect of the overlap sections 50A (see FIG. 5) at the ends of the head 50 is established. The amounts of movement in the sub-scanning direction are P₁, P₂, P₃, P₄, this sequence being repeated.

From the above-described formula (1), the amounts of movement P₁, P₂, P₃, P₄ in the sub-scanning direction satisfy (P₁+P₂+P₃+P₄)×D=n=1024. In other words, if the numbers of recording positions A₁, A₂, A₃, A₄ corresponding to the respective amounts of movement P₁, P₂, P₃, P₄ in the sub-scanning direction are considered, then P₁={A₁/(D×k)}, P₂={A₂/(D×k)}, P₃={A₃/(D×k)}, P₄={A₄/(D×k)}. For example if A₁=511, A₂=511, A₃=513 and A₄=513, then the remainders obtained when these values are divided by k (=2) are respectively 1, 0, 1, 0. In other words, when the number of recording positions corresponding to the amounts of movement in the sub-scanning direction is divided by D×k, the remainders are combinations of two pieces of 0 or 1. Furthermore, A₁+A₂+A₃+A₄ is the number of recording positions corresponding to the total amount of movement in the sub-scanning direction in one sequence, and is equal to n×k (=2048).

If k=2, then it is possible that the numbers of recording positions A₁, A₂, A₃, A₄ corresponding to the amounts of movement in the sub-scanning direction are all odd numbers and the total of these is n×k.

Furthermore, if k=2, then it is also possible that the numbers of recording positions A₁, A₂, A₃, A₄ corresponding to the amounts of movement in the sub-scanning direction are repeated odd numbers and even numbers and the total of these is n×k.

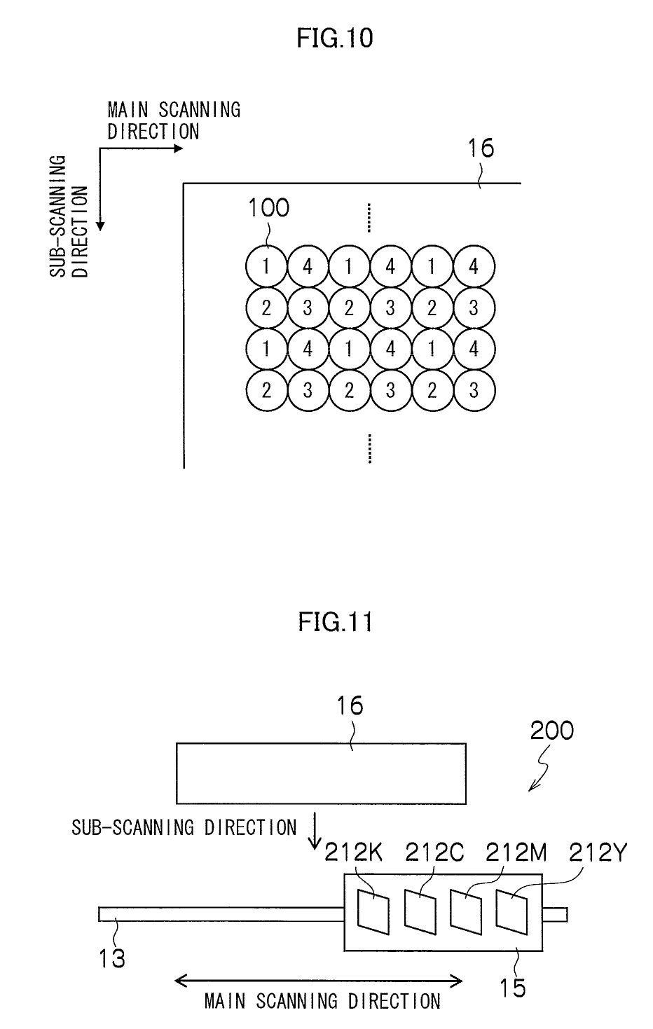

FIG. 10 is a diagram showing a dot arrangement where n=6, s=2, k=2, A₁ and A₃ are odd numbers, and A₂ and A₄ are even numbers.

As shown in FIG. 10, a dot row in which the dots recorded by a first recording action in the main scanning direction and the dots recorded by a fourth recording action in the main scanning direction are arranged alternately, and a dot row in which the dots recorded by a second recording action in the main scanning direction and the dots recorded by a third recording action in the main scanning direction are arranged alternately, are configured alternately in the sub-scanning direction. Furthermore, by selectively using the nozzles 51A-1 to 51A-6 in the leading edge portion and the trailing edge portion of the recording paper 16, as described above, it is possible to record dots without any omissions.

According to the image recording method having the composition described above, in image recording using a serial scanning type of head having the nozzle omitted sections at the end portions where the arrangement density of the nozzles becomes gradually less dense than other portions, the complementing operation is performed by overlapping the nozzle omitted sections, and furthermore when image recording is performed by means of a multi-scan method, then taking the number of nozzles to be n, taking the number of multiple scans to be s, taking the nozzle density in the sub-scanning direction to be D (dpi), taking the ratio of the recording density in the sub-scanning direction divided by the nozzle density in the sub-scanning direction to be k, and taking s×k movements in the sub-scanning direction to be one sequence, the respective movement amounts in the sub-scanning direction P₁, P₂, . . . , P_{s×k}, are determined in such a manner that the remainder values obtained by multiplying the total amount of movement to each main scanning recording position P₁, P₁+P₂, . . . , P₁+P₂+ . . . +P_{s×k}, by D×k and then dividing by k form a combination of s values from 0 to k−1, and consequently, it is possible simultaneously to achieve improvement of stripe-shaped non-uniformities originated by the ejection characteristics of the nozzles, and improvement in density non-uniformities arising in the sub-scanning direction due to the overlapping.

Furthermore, in cases where k=2 in particular, the respective movement amounts in the sub-scanning direction P₁, P₂, . . . , P_{s×k} can be determined in such a manner that the numbers of recording positions A₁, A₂, A_{s×k} corresponding to the movement amounts are all odd numbers, and the total of these numbers is n×k. If the total of the numbers of recording positions A₁, A₂, A_{s×k} is n×k, then it is also possible to repeat odd numbers and even numbers.

### Application Embodiment of Matrix Head

In the embodiment described above, image recording using the serial scanning type of head having the single nozzle row in the sub-scanning direction has been described, but the image recording method according to the present invention can also be applied to image recording using a head having nozzles arranged in a matrix configuration.

FIG. 11 is a general schematic drawing of the inkjet recording apparatus 200 according to the present application embodiment. In the following description, parts which are the same as or similar to the drawings described previously are denoted with the same reference numerals and further explanation thereof is omitted here.

The inkjet recording apparatus 200 shown in FIG. 11 has heads 212K, 212C, 212M and 212Y corresponding to the respective colors K, C, M, Y mounted on the carriage 15, and the heads 212K, 212C, 212M and 212Y each having nozzles (not shown in FIG. 11) arranged in a matrix configuration. The heads 212K, 212C, 212M and 212Y are head modules equivalent to head modules constituting full line type heads described below, and are arranged at a 90° rotation with respect to a case where they are used in the full line type heads.

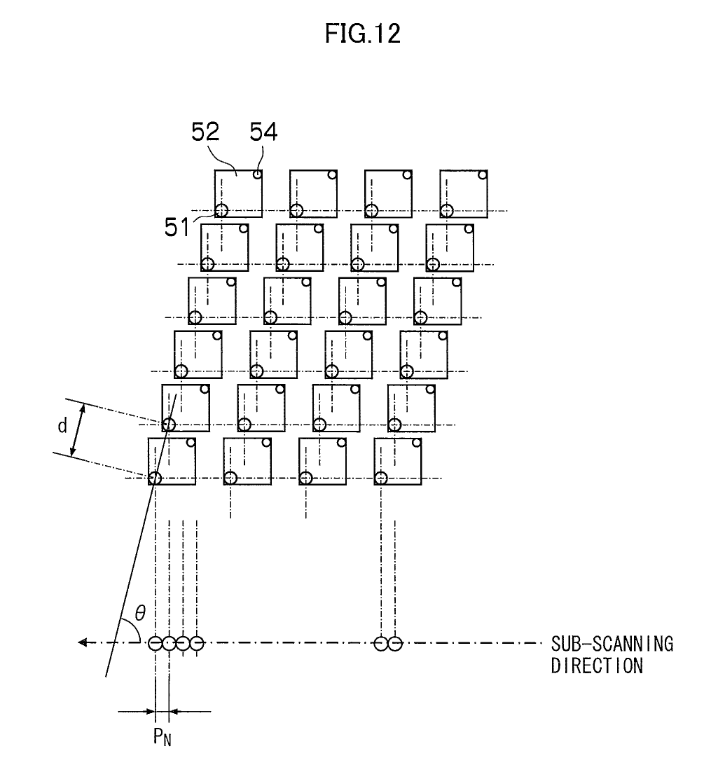

Next, the matrix arrangement of the nozzles will be described. FIG. 12 is a plan diagram showing an example of the arrangement of nozzles in one of the heads 212K, 212C, 212M and 212Y, and depicts a portion of the head in enlarged view.

As shown in FIG. 12, a high-density nozzle arrangement is achieved by arranging the plurality of nozzles 51 in a lattice according a fixed arrangement pattern following a row direction along the sub-scanning direction and an oblique column direction that forms a non-perpendicular set angle of θ with respect to the sub-scanning direction.

More specifically, by adopting a structure in which the nozzles 51 are arranged at a uniform pitch d in line with the direction forming the certain angle of θ with respect to the sub-scanning direction, the pitch P of the nozzles projected to an alignment in the sub-scanning direction is d×cos θ, and hence it is possible to treat the nozzles 51 as if they were arranged linearly at a uniform pitch of P_{N}.

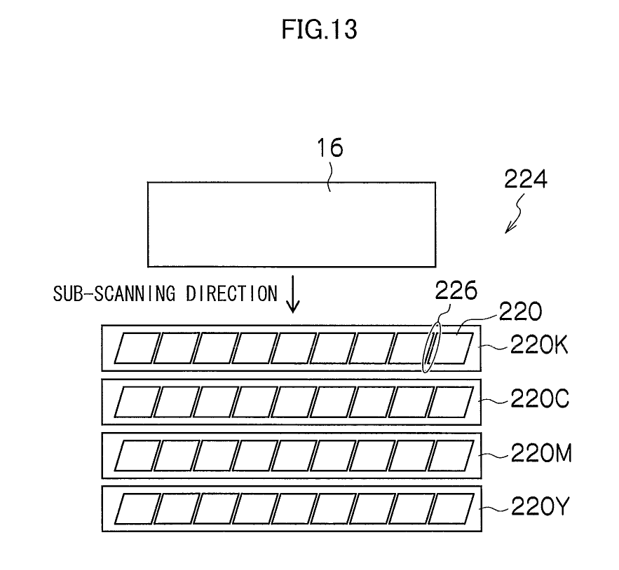

Next, a head module which constitutes the full line type head will be described. FIG. 13 is an approximate schematic drawing of an inkjet recording apparatus 224 including full line type heads 220K, 220C, 220M and 220Y composed by aligning a plurality of head modules 220 in the breadthways direction of the recording paper 16 (sub-scanning direction).

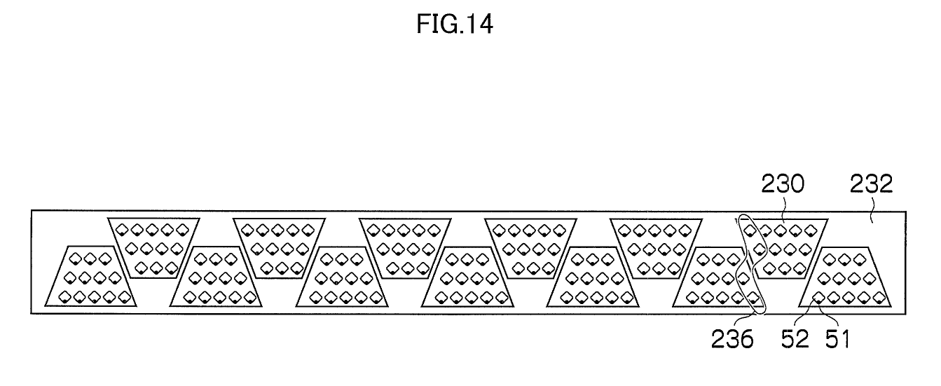

The heads 220K, 220C, 220M and 220Y shown in FIG. 13 have a parallelogram planar shape, and each form a long full line type of head corresponding to the entire width of the recording paper 16 by joining together short head modules which are narrower than the width of the recording paper 16. As shown in FIG. 14, it is also possible to compose a long full line type of head 232 by combining short head modules 230 having a trapezoid planar shape (by arranging modules with inverted upper edges and lower edges in alternating fashion).

In the full line type head of this kind, there are joints between the head modules (for example, the portions indicated by reference numeral 226 in FIG. 13 and by reference numeral 236 in FIG. 14), and the nozzle omitted parts (see FIG. 5) described above are present in these joints.

In other words, in the respective end portions of the row direction in the nozzle arrangement of the head modules (the respective end portions of the lengthwise direction of the head), the same recording density as the central portion of the head module is only achieved by mutual complement of nozzles of adjacent head modules.

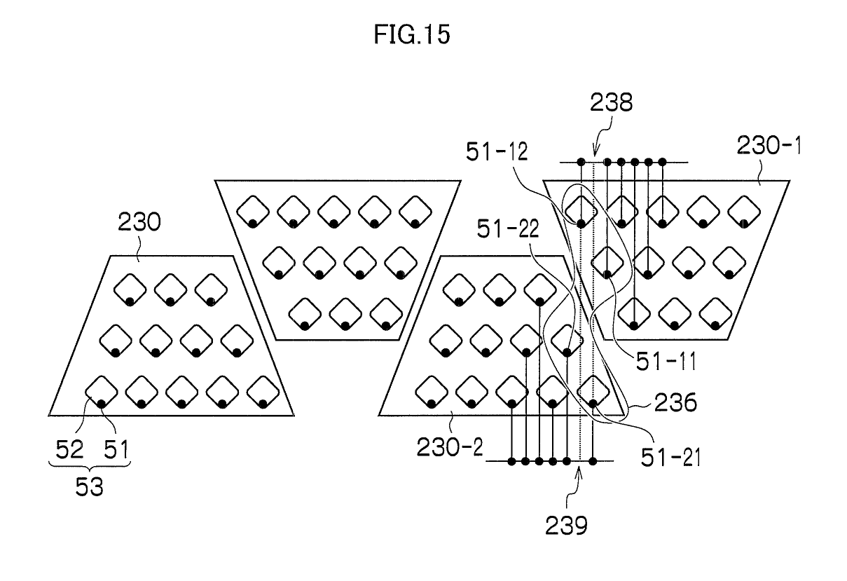

FIG. 15 is an enlarged diagram showing an enlarged view of a portion of the head module 230 shown in FIG. 14. As shown in FIG. 15, in the joint 236 between the mutually adjacent head modules 230, the nozzle 51-21 of the head module 230-2 is interpolated between the nozzle 51-11 and the nozzle 51-12 of the head module 230-1. Furthermore, the nozzle 51-12 of the head module 230-1 is interpolated between the nozzle 51-21 and the nozzle 51-22 of the head module 230-2.

When the nozzles 51 in FIG. 15 are projected to an alignment in the arrangement direction of the head modules 230 (the direction corresponding to the sub-scanning direction in FIG. 12), then if only the head module 230-1 is used, the portion indicated by reference numeral 238 is left out, and if only the head module 230-2 is used, then the portion indicated is by reference numeral 239 is left out.

In other words, if the head module 230 is used independently, then a structure similar to the head 50 shown in FIG. 5 is obtained.

In an inkjet system of a serial scanning type in the related art, by recording with a multi-pass method using nozzle rows having a uniform arrangement density, a plurality of nozzles or a plurality of recording actions contribute to recording each microscopic region, and therefore high image quality has been achieved. However, if a method of this kind is to be implemented in a head having nozzle omitted sections in the end portions of the head, as described above, then an algorithm which does not use the nozzle omitted sections is adopted.

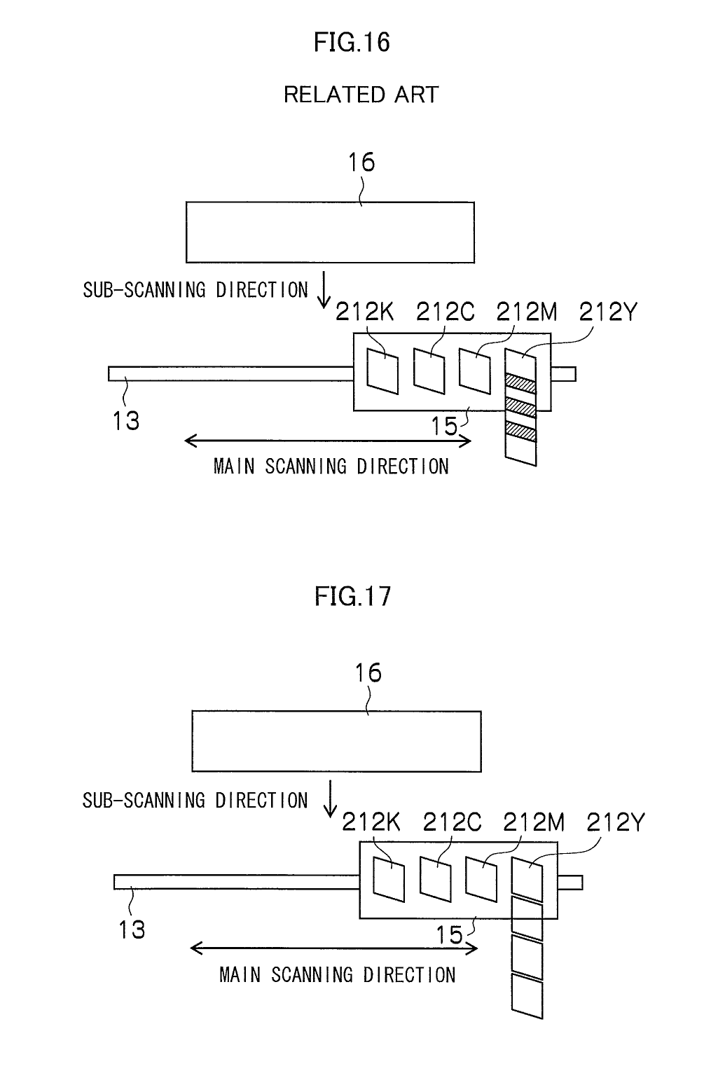

FIG. 16 is a diagram showing a schematic drawing of a state of the movement of the head 212Y when the heads 212K, 212C, 212M and 212Y and the recording paper 16 are moved relatively in the sub-scanning direction in the related art. As stated previously, the end portions (indicated by diagonal hatching) in the nozzle region (the head module 212Y) become wasted and the processing capacity declines.

FIG. 17 is a diagram showing a schematic drawing of a state of the movement of the head 212Y when the heads 212K, 212C, 212M and 212Y and the recording paper 16 are moved relatively in the sub-scanning direction, in the image recording method according to the present embodiment. As shown in FIG. 17, in the image recording method according to the present invention, waste due to the joints in the end portions of the nozzle regions is eliminated by stipulating feed amounts in the sub-scanning direction as described above, feed amounts suitable for the full line head corresponding to the entire width of the paper in FIG. 13 are achieved, and multi-pass overwriting is achieved while eliminating waste of the end portions of the nozzle regions.

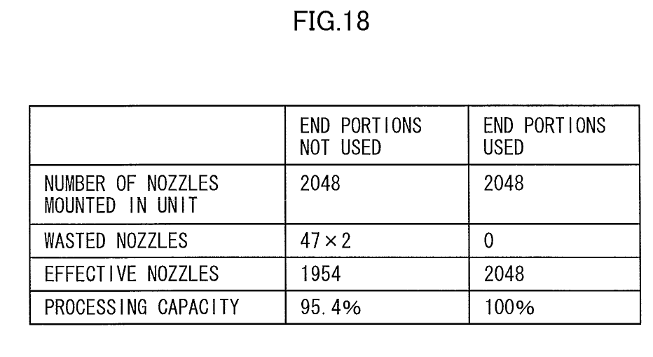

FIG. 18 is a table showing the results of comparison between an image recording method in the related art (a method which does not use the end portions), and the image recording method according to the present embodiment (the method which uses end portions). As shown in FIG. 18, it is also possible to obtain beneficial effects in improving image quality by means of multiple passes, while restricting decline in processing capacity to approximately 5%. The effective number of nozzles when the end portions are not used as shown in FIG. 18 are indicated for a case where 7 sets of 3 nozzles, 9 sets of 2 nozzles and 8 sets of 1 nozzle are not used, respectively in the left and right-hand end portions of the head modules, and hence 94 nozzles in the whole head module are not used.

Furthermore, in the example shown in FIG. 18, by using the end portions of the head modules, it is possible to set the number of nozzles to a power of two, and the number of effective nozzles can also be set to the same number. By this means, the circuit composition for data processing in relation to nozzle selection is simplified, and beneficial effects in reducing costs can be obtained.

As has become evident from the detailed description of the embodiment of the present invention given above, the present specification includes disclosure of various technical ideas including at least the following aspects of the present invention.

In an aspect of the present invention, an image recording apparatus includes: a recording head which has at least one row of recording elements arranged at a prescribed arrangement interval in a sub-scanning direction, the recording head having overlap sections at both end portions of the recording head, an arrangement density of the recording elements as expressed as a number of the recording elements per unit length gradually becoming smaller towards an end of the recording head in each of the overlap sections; a scanning device which moves the recording head in a main scanning direction with respect to a recording medium; a conveyance device which conveys the recording head and the recording medium relatively to each other in the sub-scanning direction; and a conveyance control device which controls the conveyance device, wherein where s is a number of multiple passes which is a number of recording actions on a same main scanning line, D is a maximum value of the arrangement density of the recording elements, and k is a ratio of a recording density in the sub-scanning direction with respect to the maximum value D of the arrangement density of the recording elements, the conveyance control device controls the conveyance device so as to move at least one of the head and the recording medium in such a manner that the overlap sections of the recording head are mutually complemented by means of s×k movements in the sub-scanning direction, and a remainder that is obtained by multiplying a total amount of movement to each of the s×k movements in the sub-scanning direction by the maximum value D of the arrangement density of the recording elements and multiplying a resulting product by the recording density ratio k, and then dividing a resulting product by the recording density ratio k, becomes a combination of values from 0 to k−1 that are equal in number to the number of multiple passes s.

According to this aspect of the present invention, in image recording based on a multi-pass method using a serial scanning type of recording head which has overlap sections in which the arrangement density of the recording elements gradually becomes smaller, since the relative movement of the recording head and the recording medium is controlled in such a manner that the respective overlap sections are mutually complemented by the s×k movements in the sub-scanning direction, which is the product of the number of multiple passes s and the maximum value D of the recording element density, and furthermore since the relative movement of the recording head and the recording medium is controlled in such a manner that the remainder obtained by multiplying the total amount of movement to each of the s×k movements in the sub-scanning direction by the recording element density D, multiplying by the recording density ratio k, and dividing by the recording density ratio k, is a combination of values from 0 to k−1 which are equal in number to the number of multiple passes s, then in the image recording which combines the multi-pass method and the interlace method, density non-uniformities in the joint portions in the sub-scanning direction are avoided, in addition to which stripe-shaped non-uniformities due to fluctuation in the intrinsic characteristics of the recording elements are also avoided.

In this aspect of the present invention, a movement position in the sub-scanning direction is a main scanning recording position where the respective recording actions in the main scanning direction are carried out, and if a remainder of zero is obtained when the number of recording positions corresponding to the total amount of movement to each main scanning recording position is divided by the recording density ratio k, then the recording position coincides with the position of a recording element in the sub-scanning direction, and if the remainder obtained is from 1 to k−1, then the recording position is one between recording positions coinciding with the positions of the recording elements.

The recording element is a concept which includes a composition having a nozzle, a liquid chamber accommodating liquid to be ejected from the nozzle, and a pressurization element which applies pressure to the liquid inside the liquid chamber.

The recording element density can be expressed as dpi, which is a unit of the number of recording elements per inch.

Preferably, when the recording density ratio k is 2, then values (P₁×D×k), (P₂×D×k), . . . , (P_{s×k}×D×k), which are obtained by multiplying each of the s×k amounts of movement P₁, P₂, . . . , P_{s×k} in the sub-scanning direction by the maximum value D of the arrangement density of the recording elements and then multiplying a resulting product by the recording density ratio k, are either all odd numbers or alternating odd numbers and even numbers.

According to this aspect of the present invention, if s=2 and k=2, then taking the respective amounts of movement in the sub-scanning direction to be P₁, P₂, P₃ and P₄, the remainder of (P₁×D×k)/k, the remainder of {(P₁+P₂×D×k)}/k, the remainder of {(P₁+P₂+P₃)×D×k)}/k, and the remainder of (P₁+P₂+P₃+P₄)×D×k)/k, take a combination of two values, 0 or 1.

Preferably, the maximum value D of the arrangement density of the recording elements is an integral multiple of the arrangement density of the recording elements in the overlap sections; and the conveyance control device controls the conveyance device so as to satisfy P=n/D, where n is a number of the recording elements and P is a total amount of movement produced by the s×k movements in the sub-scanning direction.

The total amount of movement produced by the s×k movements in the sub-scanning direction can be expressed as P=P₁+P₂+ . . . +P_{s×k}.

Preferably, the overlap sections have arrangements of the recording elements in which an arrangement portion where the recording element is arranged in one of the overlap sections corresponds with a non-arrangement portion where no recording element is arranged in the other of the overlap sections, and the overlap sections are mutually complemented with each other.

In other words, there is the nozzle arrangement in which when the overlap section provided in the one end portion and the overlap section provided in the other end portion are mutually overlapped, the portions where the nozzles are arranged in the respective overlap sections do not overlap with each other and the portions where no nozzles are arranged in the respective overlap sections do not overlap with each other, whereby recording is executed at the maximum value D of the nozzle density without nozzle omissions.

Preferably, the overlap sections have a same arrangement of the recording elements.

According to this aspect of the present invention, the control of the amounts of movement in the sub-scanning direction is prevented from becoming complicated.

Preferably, the recording head has the recording elements arranged in a matrix configuration in a row direction following the sub-scanning direction and a column direction which is oblique with respect to the sub-scanning direction and the main scanning direction.

According to this aspect of the present invention, it is possible to arrange the recording elements at higher density in the sub-scanning direction.

Preferably, the recording head having the recording elements arranged in the matrix configuration employs a head structure of a line type head composed by joining together a plurality of the head structures, the recording head having the recording elements arranged through a length corresponding to an entire width of the recording medium.

The end portions of the head structures that constitute the line type head have a composition that is common with the overlap sections where the arrangement density of the recording elements gradually becomes smaller.

In an aspect of the present invention, an image recording method includes: a scanning step of moving a recording head in a main scanning direction with respect to a recording medium, the recording head having at least one row of recording elements arranged at a prescribed arrangement interval in a sub-scanning direction, the recording head having overlap sections at both end portions of the recording head, an arrangement density of the recording elements as expressed as a number of the recording elements per unit length gradually becoming smaller towards an end of the recording head in each of the overlap sections; and a conveyance step of conveying the recording head and the recording medium relatively to each other in the sub-scanning direction, wherein where s is a number of multiple passes which is a number of recording actions on a same main scanning line, D is a maximum value of the arrangement density of the recording elements, and k is a ratio of a recording density in the sub-scanning direction with respect to the maximum value D of the arrangement density of the recording elements, in the conveyance step, at least one of the head and the recording medium is moved in such a manner that the overlap sections of the recording head are mutually complemented by means of s×k movements in the sub-scanning direction, and a remainder that is obtained by multiplying a total amount of movement to each of the s×k movements in the sub-scanning direction by the maximum value D of the arrangement density of the recording elements and multiplying a resulting product by the recording density ratio k, and then dividing a resulting product by the recording density ratio k, becomes a combination of values from 0 to k−1 that are equal in number to the number of multiple passes s.

Preferably, when the recording density ratio k is 2, then values (P₁×D×k), (P₂×D×k), . . . , (P_{s×k}×D×k), which are obtained by multiplying each of the s×k amounts of movement P₁, P₂, . . . , P_{s×k} in the sub-scanning direction by the maximum value D of the arrangement density of the recording elements and then multiplying a resulting product by the recording density ratio k, are either all odd numbers or alternating odd numbers and even numbers.

Preferably, the maximum value D of the arrangement density of the recording elements is an integral multiple of the arrangement density of the recording elements in the overlap sections; and in the conveyance step, the at least one of the head and the recording medium is moved so as to satisfy P=n/D, where n is a number of the recording elements and P is a total amount of movement produced by the s×k movements in the sub-scanning direction.

Preferably, the overlap sections have arrangements of the recording elements in which an arrangement portion where the recording element is arranged in one of the overlap sections corresponds with a non-arrangement portion where no recording element is arranged in the other of the overlap sections, and the overlap sections are mutually complemented with each other.

Preferably, the overlap sections have a same arrangement of the recording elements.

Preferably, the recording head has the recording elements arranged in a matrix configuration in a row direction following the sub-scanning direction and a column direction which is oblique with respect to the sub-scanning direction and the main scanning direction.

Preferably, the recording head having the recording elements arranged in the matrix configuration employs a head structure of a line type head composed by joining together a plurality of the head structures, the recording head having the recording elements arranged through a length corresponding to an entire width of the recording medium.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image recording apparatus, comprising:
a recording head which has at least one row of recording elements arranged at a prescribed arrangement interval in a sub-scanning direction, the recording head having overlap sections at both end portions of the recording head, an arrangement density of the recording elements as expressed as a number of the recording elements per unit length gradually becoming smaller towards an end of the recording head in each of the overlap sections;
a scanning device which moves the recording head in a main scanning direction with respect to a recording medium;
a conveyance device which conveys the recording head and the recording medium relatively to each other in the sub-scanning direction; and
a conveyance control device which controls the conveyance device,
wherein where s is a number of multiple passes which is a number of recording actions on a same main scanning line, D is a maximum value of the arrangement density of the recording elements, and k is a ratio of a recording density in the sub-scanning direction with respect to the maximum value D of the arrangement density of the recording elements,
the conveyance control device controls the conveyance device so as to move at least one of the head and the recording medium in such a manner that the overlap sections of the recording head are mutually complemented by means of s×k movements in the sub-scanning direction, and a remainder that is obtained by multiplying a total amount of movement to each of the s×k movements in the sub-scanning direction by the maximum value D of the arrangement density of the recording elements and multiplying a resulting product by the recording density ratio k, and then dividing a resulting product by the recording density ratio k, becomes a combination of values from 0 to k−1 that are equal in number to the number of multiple passes s.

2. The image recording apparatus as defined in claim 1, wherein when the recording density ratio k is 2, then values (P₁×D×k), (P₂×D×k), . . . , (P_{s×k}×D×k), which are obtained by multiplying each of the s×k amounts of movement P₁, P₂, . . . , P_{s×k} in the sub-scanning direction by the maximum value D of the arrangement density of the recording elements and then multiplying a resulting product by the recording density ratio k, are either all odd numbers or alternating odd numbers and even numbers.

3. The image recording apparatus as defined in claim 1, wherein:
the maximum value D of the arrangement density of the recording elements is an integral multiple of the arrangement density of the recording elements in the overlap sections; and
the conveyance control device controls the conveyance device so as to satisfy P=n/D, where n is a number of the recording elements and P is a total amount of movement produced by the s×k movements in the sub-scanning direction.

4. The image recording apparatus as defined in claim 1, wherein the overlap sections have arrangements of the recording elements in which an arrangement portion where the recording element is arranged in one of the overlap sections corresponds with a non-arrangement portion where no recording element is arranged in the other of the overlap sections, and the overlap sections are mutually complemented with each other.

5. The image recording apparatus as defined in claim 1, wherein the overlap sections have a same arrangement of the recording elements.

6. The image recording apparatus as defined in claim 1, wherein the recording head has the recording elements arranged in a matrix configuration in a row direction following the sub-scanning direction and a column direction which is oblique with respect to the sub-scanning direction and the main scanning direction.

7. The image recording apparatus as defined in claim 6, wherein the recording head having the recording elements arranged in the matrix configuration employs a head structure of a line type head composed by joining together a plurality of the head structures, the recording head having the recording elements arranged through a length corresponding to an entire width of the recording medium.

8. An image recording method, comprising:
a scanning step of moving a recording head in a main scanning direction with respect to a recording medium, the recording head having at least one row of recording elements arranged at a prescribed arrangement interval in a sub-scanning direction, the recording head having overlap sections at both end portions of the recording head, an arrangement density of the recording elements as expressed as a number of the recording elements per unit length gradually becoming smaller towards an end of the recording head in each of the overlap sections; and
a conveyance step of conveying the recording head and the recording medium relatively to each other in the sub-scanning direction,
wherein where s is a number of multiple passes which is a number of recording actions on a same main scanning line, D is a maximum value of the arrangement density of the recording elements, and k is a ratio of a recording density in the sub-scanning direction with respect to the maximum value D of the arrangement density of the recording elements,
in the conveyance step, at least one of the head and the recording medium is moved in such a manner that the overlap sections of the recording head are mutually complemented by means of s×k movements in the sub-scanning direction, and a remainder that is obtained by multiplying a total amount of movement to each of the s×k movements in the sub-scanning direction by the maximum value D of the arrangement density of the recording elements and multiplying a resulting product by the recording density ratio k, and then dividing a resulting product by the recording density ratio k, becomes a combination of values from 0 to k−1 that are equal in number to the number of multiple passes s.

9. The image recording method as defined in claim 8, wherein when the recording density ratio k is 2, then values (P₁×D×k), (P₂×D×k), (P_{s×k}×D×k), which are obtained by multiplying each of the s×k amounts of movement P₁, P₂, . . . , P_{s×k} in the sub-scanning direction by the maximum value D of the arrangement density of the recording elements and then multiplying a resulting product by the recording density ratio k, are either all odd numbers or alternating odd numbers and even numbers.

10. The image recording method as defined in claim 8, wherein:
the maximum value D of the arrangement density of the recording elements is an integral multiple of the arrangement density of the recording elements in the overlap sections; and
in the conveyance step, the at least one of the head and the recording medium is moved so as to satisfy P=n/D, where n is a number of the recording elements and P is a total amount of movement produced by the s×k movements in the sub-scanning direction.

11. The image recording method as defined in claim 8, wherein the overlap sections have arrangements of the recording elements in which an arrangement portion where the recording element is arranged in one of the overlap sections corresponds with a non-arrangement portion where no recording element is arranged in the other of the overlap sections, and the overlap sections are mutually complemented with each other.

12. The image recording method as defined in claim 8, wherein the overlap sections have a same arrangement of the recording elements.

13. The image recording method as defined in claim 8, wherein the recording head has the recording elements arranged in a matrix configuration in a row direction following the sub-scanning direction and a column direction which is oblique with respect to the sub-scanning direction and the main scanning direction.

14. The image recording method as defined in claim 13, wherein the recording head having the recording elements arranged in the matrix configuration employs a head structure of a line type head composed by joining together a plurality of the head structures, the recording head having the recording elements arranged through a length corresponding to an entire width of the recording medium.
